(19) United States
(12) Patent Application Publication
(10) Pub. No.: US 2014/0211638 A1
(43) Pub. Date: Jul. 31, 2014

(54) METHOD AND SYSTEM FOR DETECTING SLEEPING CELL

(71) Applicant: Huawei Technologies Co., Ltd., Shenzhen (CN)

(72) Inventor: Yinghua HUANG, Shanghai (CN)

(73) Assignee: Huawei Technologies Co., Ltd., Shenzhen (CN)

(21) Appl. No.: 14/231,021

(22) Filed: Mar. 31, 2014

Related U.S. Application Data
(63) Continuation of application No. PCT/CN2011/080466, filed on Sep. 30, 2011.

(51) Int. Cl. H04W 24/06

(52) U.S. Cl. CPC H04W 24/06
USPC 370/249

(57) ABSTRACT

Embodiments of the present invention provide a method for detecting a sleeping cell and a system including: a network management device and a base station, where the network management device is configured to send a detection command being used to indicate performing a loopback test for the base station, where the loopback test is a test for a cell controlled by the base station; the base station is configured to receive the detection command from the network management device, perform the loopback test for the cell by simulating the user equipment, generate a detection result of a sleeping cell according to a result of the loopback test, and send the detection result of the sleeping cell to the network management device; and the network management device is further configured to determine whether the cell is a sleeping cell according to the detection result of the sleeping cell.

### CROSS-REFERENCE TO RELATED APPLICATIONS

This application is a continuation of International Patent Application No. PCT/CN2011/080466, filed on Sep. 30, 2011, which is hereby incorporated by reference in its entirety.

### FIELD OF THE INVENTION

Embodiments of the present invention relate to the field of communication technologies, and in particular, to a method and a system for detecting a sleeping cell.

### BACKGROUND OF THE INVENTION

Wireless communication network operators need to construct and maintain entire communication systems, and also need to pay the same effort in planning and optimizing wireless communication networks as in constructing and configuring wireless communication networks.

When a software or hardware failure occurs in a base station of cells, cell services become abnormal. Cells with exceptional services are generally called sleeping cells. In a sleeping cell, user equipments in the whole cell cannot implement services normally, which may be caused by a physical layer failure, a transmission failure, software and hardware failures, or the like in the cell. If the sleeping cell cannot provide normal services, the network performance is greatly affected. Therefore, sleeping cell detection serves as a basis for cell failure management.

In the prior art, wireless communication networks or some network elements or servers usually select some user equipments in a cell automatically, and the selected user equipments report specific performance parameters of the cell to determine whether the cell is a sleeping cell. However, in a cell with relatively low traffic, information needed to determine whether the cell is a sleeping cell cannot be obtained.

### SUMMARY OF THE INVENTION

Embodiments of the present invention provides a method and a system for detecting a sleeping cell, so that information needed to determine a sleeping cell can be obtained timely and a detection result of a sleeping cell can be determined.

In one aspect, a system for detecting a sleeping cell is provided, including: a control module, configured to generate a test command, where the test command is used to indicate performing a loopback test for a base station by simulating a user equipment, where the loopback test is a test for a cell controlled by the base station; and an execution module, configured to: receive the test command from the control module, perform, according to the test command, a loopback test for the base station by simulating the user equipment, and output a result of the loopback test to the control module. The control module is further configured to output a detection result of a sleeping cell according to the result of the loopback test, where the detection result of the sleeping cell is used to determine whether the cell is a sleeping cell.

In another aspect, a system for detecting a sleeping cell is provided, including a network management device and a base station. The network management device is configured to generate a detection command, where the detection command is used to indicate performing a loopback test for the base station, where the loopback test is a test for a cell controlled by the base station. The base station is configured to: receive the detection command from the network management device, perform the loopback test by simulating a user equipment, generate a detection result of a sleeping cell according to a result of the loopback test, and send the detection result of the sleeping cell to the network management device. The network management device is further configured to determine whether the cell is a sleeping cell according to the detection result of the sleeping cell.

In another aspect, a method for detecting a sleeping cell is provided, including: when acquiring that a loopback test needs to be performed, performing a loopback test for a base station by simulating a user equipment, where the loopback test is a test for a cell controlled by the base station; and outputting a result of the loopback test, where the result of the loopback test is used to determine whether the cell is a sleeping cell.

In another aspect, a method for detecting a sleeping cell is provided, including: if determining that a potential failure occurs in a cell, generating a detection command, where the detection command is used to instruct to detect a sleeping cell; and determining whether the cell is a sleeping cell according to a detection result of a sleeping cell.

According to the technical solutions, a loopback test is performed for the base station by simulating a user equipment, so that information needed to determine a sleeping cell can be obtained timely and a detection result of a sleeping cell can be determined. In this way, a sleeping cell can be discovered timely without assistance of the user equipment in a cell.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these drawings without creative efforts.

FIG. 1 is a block diagram of a system for detecting a sleeping cell according to an embodiment of the present invention;

FIG. 2 is a block diagram of a system for detecting a sleeping cell according to another embodiment of the present invention;

FIG. 3a is a schematic architecture diagram of a system for detecting a sleeping cell according to another embodiment of the present invention;

FIG. 3b is a schematic architecture diagram of a system for detecting a sleeping cell according to another embodiment of the present invention;

FIG. 4 is a block diagram of a system for detecting a sleeping cell according to another embodiment of the present invention;

FIG. 5 is a schematic flowchart of a method for detecting a sleeping cell according to an embodiment of the present invention; and

FIG. 6 is a flowchart of a method for detecting a sleeping cell according to another embodiment of the present invention.

### DETAILED DESCRIPTION OF THE EMBODIMENTS

The following clearly and describes the technical solutions in the embodiments of the present invention with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

Currently, when a sleeping cell is detected, the key performance indicator (KPI) of a cell can be collected in a monitoring period, and then whether the cell is a sleeping cell is determined according to the KPI of the cell. For example, if a cell has no traffic (traffic is a KPI), the cell is considered as a sleeping cell in the prior art. However, in the prior art, detecting a sleeping cell according to whether a cell has traffic has a risk of misjudgment. For example, if no user equipment initiates a service in a monitoring period, misjudgment may occur. In an embodiment of the present invention, automatic detection of a sleeping cell is implemented timely and accurately by simulating an access/calling process of a user equipment.

An embodiment of the present invention can be used in different standards of radio networks. In different systems, a radio access network may include different network elements. For example, in an LTE (Long Term Evolution), network elements of the radio access network include an eNB (evolved NodeB); in a WCDMA (Wideband Code Division Multiple Access), network elements of the radio access network include an RNC (Radio Network Controller) and a NodeB. Similarly, in other radio networks such as WiMax (Worldwide Interoperability for Microwave Access), solutions similar to those provided in embodiments of the present invention may also be adopted, where related modules in a base station system may be different from those in the embodiments of the present invention.

In an embodiment of the present invention, performing a loopback test may refer to a process of triggering sending of a test signal to a base station (an antenna port or other internal modules of the base station) and trying to receive a feedback signal from the base station (an antenna port or other internal modules of the base station). It is also understandable that loopback refers to a process of performing communication loopback with a base station by the base station and a loopback test refers to a test used to check whether the base station or a cell controlled by the base station can implement loopback. If the following four actions are performed successfully: A base station sends a test signal, the base station receives the test signal, the base station sends a feedback signal in response to the test signal, and the base station receives the feedback signal, the loopback test is successful. A loopback test failure means that at least one of the four actions in the process fails. Of course, the loopback test may be not limited to the four actions. If at least one of the four actions fails due to other actions included in the loopback test or results of the other actions, the loopback test fails. One or more steps in the four actions involved in the above process may be performed by an antenna port, or one internal module or multiple internal modules of the base station. The test signal may be sent to the base station or a cell controlled by the base station. For example, the test signal may be a call signal, and the feedback signal may be a signal indicating whether a call is connected. For brief description, a test of a call is taken as an example for description in the following, but embodiments of the present invention are not limited to the specific forms of the test signal and feedback signal, for example, a dedicated test signal may also be used.

In particular, performing a loopback test for a cell controlled by the base station may refer to performing the loopback test for an antenna port or one internal module or multiple modules corresponding to the cell in the base station. For example, when one base station controls multiple cells, a loopback test can be performed for the antenna port and/or internal modules corresponding to one particular cell. The antenna port and/or internal modules corresponding to the particular cell can be shared with other cells controlled by the base station, or can be specifically used for the particular cell.

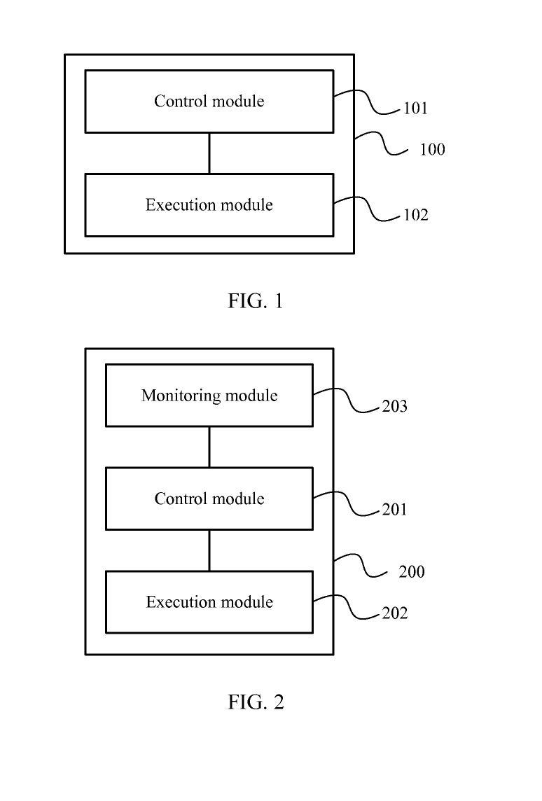

FIG. 1 is a block diagram of a system for detecting a sleeping cell according to an embodiment of the present invention. A system 100 in FIG. 1 includes a control module 101 and an execution module 102.

The control module 101 is configured to generate a test command, where the test command is used to indicate performing a loopback test for the base station by simulating a user equipment, where the loopback test is a test for a cell controlled by the base station.

For example, the test command generated by the control module 101 can carry information indicating start of a test. The test command may adopt the form of a dedicated signaling message, or may be carried by using an existing message, which is not limited in the present invention.

Optionally, as an embodiment, the control module 201 can generate the test command when a potential failure occurs in a cell (that is, there is a possibility that the cell is a sleeping cell). The potential failure of the cell may be determined according to the KPI and/or other parameters of the cell, for example, when the cell has no traffic, it can be determined that a potential failure occurs in the cell. The parameters used to determine a potential failure are not limited in the embodiment of the present invention.

Optionally, as another embodiment, the control module 101 may generate one or more test commands to instruct the executing unit 102 to perform a loopback test once or multiple times. Each test command can be used to initiate one loopback test, that is, one test command corresponds to a requirement of one loopback test. When more than one test commands are used, the transmission forms of these test commands are not limited in the present invention. For example, these test commands may be carried in one or more messages, or one test command and information such as the times of repeating the test command may be carried in one message.

The execution module 102 receives a test command from the control module 101, performs, according to the test command, a loopback test for the base station by simulating the user equipment, and outputs a result of the loopback test to the control module 101.

Optionally, as an embodiment, the execution module 102 can call the base station by simulating the user equipment, where the call is a call to a cell controlled by the base station, and determine a result of the loopback test according to whether the call is successful.

For example, as an example, the execution module 102 can send a test signal to the base station, where the test signal is used to initiate a call to a cell controlled by the base station, and receive a feedback signal from the base station in response to the test signal. If the feedback signal indicates that the call is successful, a result of the loopback test output is that the loopback test is successful; if the feedback signal indicates that the call fails, a result of the loopback test output is that the loopback test fails. Or, as another example, the execution module 102 can send a test signal to the base station, where the test signal is used to initiate a call to a cell controlled by the base station. If a feedback signal from the base station in response to the test signal is received, a result of the loopback test output is that the loopback test is successful. If a feedback signal from the base station in response to the test signal is not received, a result of the loopback test output is that the loopback test fails.

The control module 101 outputs a detection result of a sleeping cell according to the result of the loopback test, where the detection result of the sleeping cell is used to determine whether the cell is a sleeping cell.

For example, when the result of the loopback test indicates that the loopback test is successful, the control module 101 may output a detection result of a sleeping cell indicating that the cell is not a sleeping cell; when the result of the loopback test indicates that the loopback test fails, the control module 101 may output a detection result of a sleeping cell indicating that the cell is a sleeping cell.

In another aspect, if a loopback test is performed multiple times, a detection result of a sleeping cell can be determined by combining loopback test results of the multiple times. For example, if a result of the loopback test indicates that the test is successful, the cell may not be considered as a sleeping cell. Or, if a result of the loopback test indicates that the test fails, the cell may be considered as a sleeping cell.

Optionally, as another embodiment, the times of test success or test failure may be considered. For example, if the number of the times of test success reaches a predetermined times (for example, three times), the cell may not be considered as a sleeping cell. Or, if the number of the times of test failure reaches a predetermined times (for example, three times), the cell may be considered as a sleeping cell.

Optionally, as another embodiment, the percentage of the number of the times of test success or test failure in the total number of tests may be considered. For example, if most of the tests (for example, 90%) are successful, the cell may not be considered as a sleeping cell. Or, if most of the tests (for example, 90%) fail, the cell may be considered as a sleeping cell.

The numerical values do not limit the scope of the present invention. In the embodiment of the present invention, the specific numerical values of the predetermined times or percentage may be adjusted according to detection precision or accuracy requirements.

Optionally, as an embodiment, the control module 101 may be a module in the network management device, and the execution module 102 may be a module in the base station. Or, the control module 101 and the execution module 102 may be modules in the base station.

In the embodiment of the present invention, a loopback test is performed for a base station by simulating a user equipment, so that information needed to determine a sleeping cell can be obtained timely and a detection result of a sleeping cell can be determined. In this way, a sleeping cell can be discovered timely without assistance of a user equipment in a cell.

In the prior art, when a cell has no traffic, the cell may be directly determined as a sleeping cell, thereby causing misjudgment easily. However, in the embodiment of the present invention, when a cell has no traffic, a loopback test is performed by simulating a user equipment, and whether the cell is a sleeping cell is determined according to a result of the loopback test, so that the accuracy of determining a sleeping cell can be increased.

FIG. 2 is a block diagram of a system for detecting a sleeping cell according to another embodiment of the present invention. A system 200 in FIG. 2 includes a control module 201, an execution module 202, and a monitoring module 203.

The monitoring module 203 generates a detection command when it is determined that a potential failure occurs in a cell, and sends the detection command to the control module 201.

Optionally, as an embodiment, the monitoring module 203 can generate the detection command when a potential failure occurs in the cell (that is, there is a possibility that the cell is a sleeping cell). The potential failure of the cell may be determined according to the KPI and/or other parameters of the cell, for example, when the cell has no traffic, it can be determined that a potential failure occurs in the cell. The parameters used to determine a potential failure are not limited in the embodiment of the present invention.

Similar to the control module 101 in FIG. 1, the control module 201 generates a test command, where the test command is used to indicate performing a loopback test for the base station by simulating the user equipment, where the loopback test is a test for a cell controlled by the base station. Specifically, the control module 201 may acquire, according to the detection command received from the monitoring module 203, that a loopback test needs to be performed, and then generate the test command according to the detection command. The test command generated by the control module 201 is similar to the test command generated by the control module 101 in FIG. 1, so details are not described again.

The execution module 202 receives a test command from the control module 201, performs, according to the test command, a loopback test for the base station by simulating the user equipment, and outputs a result of the loopback test to the control module 201. Operations performed by the execution module 202 are similar to those performed by the execution module 102 in FIG. 1, so details are not described again.

The control module 201 outputs a detection result of a sleeping cell according to the result of the loopback test, where the detection result of the sleeping cell is used to determine whether the cell is a sleeping cell. The detection result of the sleeping cell output by the control module 201 is similar to that output by the control module 101 in FIG. 1, so details are not described again.

The control module 201 can output a detection result of a sleeping cell to the monitoring module 203. The monitoring module 203 determines whether the cell is a sleeping cell according to the detection result of the sleeping cell.

For example, when the detection result of the sleeping cell indicates that the detection is successful, the monitoring module 203 may determine that the cell is not a sleeping cell; when the detection result of the sleeping cell indicates that the detection fails, the monitoring module 203 may determine that the cell is a sleeping cell.

Optionally, as an embodiment, the monitoring module 203 may be located in a management network (for example, a network management device), while the control module 201 and the execution module 202 may be located in an access network (for example, a base station or a base station controller or a place nearby the base station or the base station controller). For example, the monitoring module 203 may be a module in the network management device on the management network, while the control module 201 and the execution module 202 may be modules in a base station, where the base station is located in the access network.

Or, as another embodiment, the monitoring module 203 and the control module 202 may be located in a management network, while the execution module 201 may be located in an access network. For example, the monitoring module 203 and the control module 202 may be modules in a network management device on the management network, while the execution module 202 may be a module in a base station, where the base station is located in the access network.

Or, as another embodiment, the monitoring module 203, the control module 201, and the execution module 202 may be located in an access network. For example, the monitoring module 203, the control module 201, and the execution module 202 may be modules in a base station, where the base station is located in the access network.

In the embodiment of the present invention, a loopback test is performed for the base station by simulating a user equipment, so that information needed to determine a sleeping cell can be obtained timely and a detection result of a sleeping cell can be determined. In this way, a sleeping cell can be discovered timely without assistance of the user equipment in a cell.

The following specifically describes an example of triggering detection by the monitoring module according to a potential failure status of a cell, but the embodiment of the present invention is not limited to this example. For example, the test command or detection command may also be generated based on other cases. Or, in the embodiment of the present invention, a test command or a detection command may be generated periodically, or a loopback test is started when a test command is received, where the test command is generated by an external device periodically or according to other reasons. All these modifications fall into the scope of the embodiments of the present invention.

According to the embodiment of the present invention, the control module 101 or 201 may generate a test command for each loopback test point of at least one loopback test point of a base station, where the at least one loopback test point is an antenna port of the base station or is distributed between the antenna port of the base station and a core network. In this case, the control module 101 or 201 may carry information of a loopback test point in the test command (for example, a loopback test point number or other identifiers of corresponding interfaces), so that the execution module 102 or 202 generates a test signal in response to the loopback test point, and sends the generated detest signal to a module corresponding to the loopback test point. In addition, one or more test commands may be generated for each loopback test point.

In this case, the control module 101 or 201 may further determine a fault location of the base station according to loopback test results of two loopback test points of the at least one loopback test point.

In addition, a test is performed for multiple loopback test points of the base station, and a fault location of the base station may be determined according to loopback test results of two loopback test points of the multiple loopback test points, so that faults can be solved quickly.

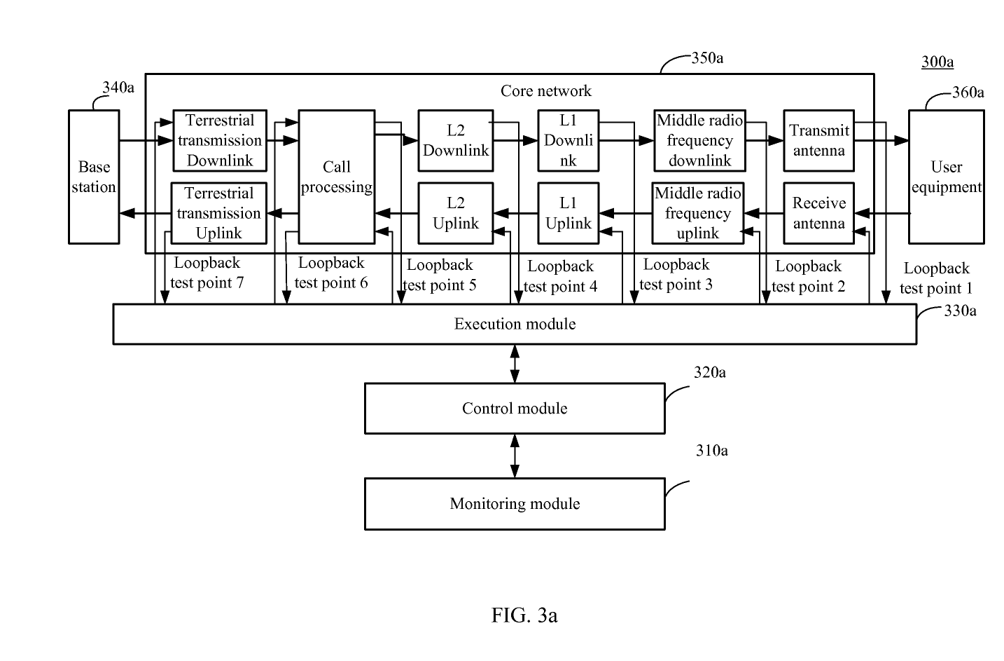

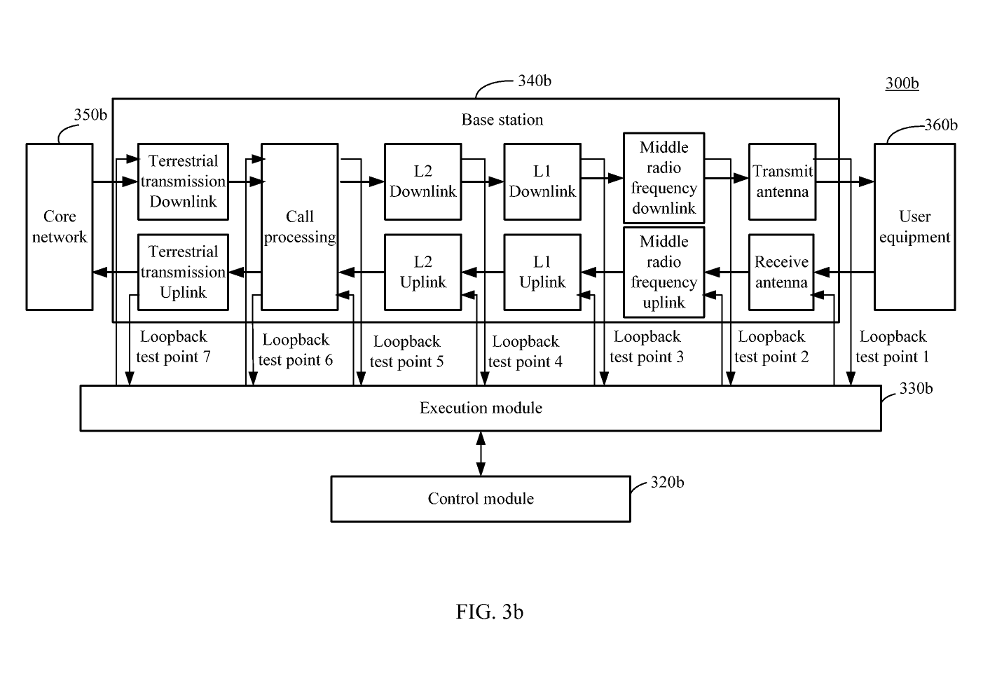

FIG. 3a is a schematic architecture diagram of a system for detecting a sleeping cell according to another embodiment of the present invention.

Referring to FIG. 3a, a user equipment 360a can communicate with a core network 350a through an uplink channel and a downlink channel of a base station 340a. The base station 340a includes: an antenna (including a transmit antenna and a receive antenna), a middle radio frequency module (including a middle radio frequency uplink part and a middle radio frequency uplink part), an L1 module (including an L1 uplink part and an L1 downlink part), an L2 module (including an L2 uplink part and an L2 downlink part), a call processing module, and a terrestrial transmission module (including a terrestrial transmission uplink part and a terrestrial transmission downlink part).

A monitoring module 310a is an example of the monitoring module, a control module 320a is an example of the control module, and an execution module 330a is an example of the execution module.

A loopback test point 1 to a loopback test point 7 are interfaces between the execution module 330a and the base station, where the execution module 330a sets up connection with the base station 340a through the loopback test points, and a loopback test is performed for one or a plurality of these loopback test points. For example, a loopback test may be performed by initiating a call to the call processing module through each loopback test point. The embodiment of the present invention does not limit the specific form of a test signal, and may adopt forms other than a test of a call, for example, a dedicated test signal.

Referring to FIG. 3a, the loopback test points 1 to 7 are located on an antenna port or between different modules of the base station 340a. For example, the loopback test point 1 is located on the antenna port of the base station 340a, and the loopback test point 3 is located between the L1 module and the middle radio frequency module of the base station 340a. Corresponding to different loopback test points, test signals generated by the execution module 330a may be different. For example, for the loopback test point 1, a test signal of the execution module 330a may be similar to a call signal of the user equipment 360a, and scenario simulation such as signal attenuation and loss may be considered. For the loopback test point 3, a test signal of the execution module 330a may be similar to a baseband signal obtained after a call signal is received by an antenna and undergoes middle radio frequency processing, so that the L1 module can directly process the test signal.

An example that a loopback test is performed by accessing the loopback test point 1 (the antenna port of the base station) is taken for illustration. Loopback tests for other loopback test points are similar.

The monitoring module 310a determines, according to a KPI of a cell, whether a potential failure occurs in the cell. For example, if a cell has no traffic, the monitoring module 310a determines that the cell may be a sleeping cell (that is, a potential failure occurs) and that there is a need to perform a further test by simulating the user equipment. The monitoring module 310a generates a detection command after determining that a potential failure occurs in the cell, and sends the detection command to the control module 320a to instruct to detect a sleeping cell. The specific KPI used to determine the potential failure of the cell may be set according to actual applications, which is not specifically limited in the embodiment of the present invention.

The control module 320a generates a test command according to the received detection command, and sends the test command to the execution module 330a. In this embodiment, there may be one or more test commands for each loopback test point. In addition, the test command may carry information of a loopback test point (for example, a loopback test point number or other identifier information). For example, the control module 320a may send multiple test commands for the loopback test point 1 to the execution module 330a to perform a loopback test for the loopback test point 1 multiple times.

The execution module 330a performs, according to the test command, a loopback test for the base station of the cell by simulating the user equipment, and outputs a result of the loopback test. For example, for the loopback test point 1, the execution module 330a may send a call signal, and perform a complete call by simulating the user equipment. Specifically, the call signal, which is obtained after the processing of the receive antenna, the positive radio frequency uplink part, the L1 uplink part, the L2 uplink part, and the call processing module in turn, is sent, and a feedback signal in response to the call signal, which is obtained after the processing of the L2 downlink part, the L1 downlink part, the middle radio frequency downlink part, and the transmit antenna in turn, is sent. The execution module 330a receives the feedback signal, and determines, according to the feedback signal, whether the test is successful. If the feedback signal is normal (that is, similar to a feedback signal that should be generated in a normal call), the result of the test may indicate that the test is successful; on the contrary, if the feedback signal is exceptional or no feedback signal is received, the result of the test may indicate that the test fails.

In this case, the execution module 330a may implement complete functions of a user equipment by simulating the user equipment. The execution module 330a is directly connected to the base station on the antenna port of the base station to perform a loopback test for the antenna and determine whether a call or a loopback test is successful. The execution module 330a feeds back each loopback test result to the control module 320a. For example, if a call is successful, a result of the loopback test indicating that the call is successful is fed back to the loopback test control module 320a. Optionally, to increase the accuracy of measurement, the actual path loss of a radio signal may be simulated by certain means.

The control module 320a determines a detection result of a sleeping cell according to a result of the loopback test. For example, when the control module 320a instructs the execution module 330a repeatedly to perform a test for the loopback test point 1 multiple times, if the multiple loopback tests fail, the control module 320a determines that the detection fails. In this way, the reliability of the test can be increased. Or, if a loopback test is successful once or predetermined times, the control module 320a determines that the detection is successful. The control module 320a feeds back, to the monitoring module 310a, a detection result of a sleeping cell indicating that the detection is successful or fails.

The monitoring module 310a determines, according to the detection result of the sleeping cell, whether the cell is a sleeping cell. If the detection result of the sleeping cell indicates that the detection is successful, the monitoring module 310a may determine that the cell is not a sleeping cell; if the detection result of the sleeping cell indicates that the detection fails, the monitoring module 310a may determine that the cell is a sleeping cell.

The test processes for other loopback test points are similar so long as changes are made to a test signal on each loopback test point adaptively.

Further, according to another embodiment of the present invention, to determine a fault location of a base station, tests may be performed for multiple loopback test points of the base station 340a, and the fault location of the base station is determined according to test results of the multiple loopback test points.

In this case, after receiving a detection command from the monitoring module 310a, the control module 320a sends, to the execution module 330a, loopback test commands for some or all loopback test points of the loopback test points 1 to 7, to perform a loopback test for each loopback test point. It should be noted that the loopback tests for the loopback test points may be performed in a predetermined sequence or concurrently, which is not specifically limited in the embodiment of the present invention.

The execution module 330a performs a loopback test according to a test command of the control module 320a. Taking the loopback test point 3 as an example, the execution module 330a can perform a baseband loopback test, and is directly connected to the base station 340a at the L1 module of the base station 340a. It should be noted that except the loopback test for the loopback test point 1 (the antenna port of the base station), loopback tests for other loopback test points do not need to implement complete functions of the user equipment. For example, when a loopback test is performed for the loopback test point 3, an interface between the execution module 330a and the base station 340a is similar to an interface between the L1 and the middle radio frequency, so that functions of the middle radio frequency do not need to be implemented.

The execution module 330a determines whether a loopback test for a loopback test point n (n=1, 2, 3, . . . , 7) is successful and feeds back a corresponding test result to the control module 320a.

The control module 320a determines a fault location according to a test result of each loopback test point. As described above, the control module 320a may determine a detection result of a sleeping cell according to the test result. For example, when the test for the loopback test point 3 fails but the test for the loopback test point 4 is successful, the control module 320a may determine that a fault is located between the loopback test point 3 and the loopback test point 4, that is, the fault is on the L1 module.

The control module 320a feeds back a detection result of a sleeping cell and/or a fault location to the monitoring module 310a. For example, the control module 320a not only can feed back a detection result of a sleeping cell indicating whether the detection is successful to the monitoring module 310a, but also can feed back a fault location to the monitoring module 310a when the detection result indicates that the detection fails.

Similarly, if the detection result of the sleeping cell indicates that the detection is successful, the monitoring module 310a may determine that the cell is not a sleeping cell. If the detection result of the sleeping cell indicates that the detection fails, the monitoring module 310a determines that the cell is a sleeping cell, and may determine a fault location in the base station according to the fault location information carried in the detection result of the sleeping cell.

It should be noted that the monitoring module 310a and the control module 320a may be located in an access network (for example, a base station or a base station controller) or in a management network (for example, a network management system), or be distributed on an access network and a management network. The execution module 330a may be located in the access network. The modules may be separate modules located in the same or different physical entities or be implemented by using one physical entity or logical entity.

FIG. 3b is a schematic architecture diagram of a system 300b for detecting a sleeping cell according to another embodiment of the present invention.

An example that a loopback test is performed by accessing a loopback test point 1 (an antenna port of a base station) is taken for illustration. Loopback tests for other loopback test points are similar.

Referring to FIG. 3b, a control module 320b is an example of the control module 101 in FIG. 1, and may determine, according to a KPI of a cell, whether a potential failure occurs in the cell. For example, if the cell has no traffic, the control module 320b determines that a potential failure occurs in the cell, the cell may be a sleeping cell, and that there is a need to perform a further test by simulating a user equipment. After determining that a potential failure occurs in the cell, the control module 320b generates a test command, and sends the test command to an execution module 330b. The control module 320b may generate one or more test commands.

The execution module 330b performs, according to the test command, a loopback test for a base station of the cell by simulating the user equipment, and feeds back a result of the loopback test to the control module 320b. Functions of the execution module 330b for performing a loopback test are similar to corresponding functions of the execution module 330a in FIG. 3a, and are not further described herein.

The control module 320b determines, according to the result of the loopback test, whether the cell is a sleeping cell. If the result of the loopback test indicates that the test is successful, the control module 320b may determine that the cell is not a sleeping cell; if the result of the loopback test indicates that the test fails, the control module 320b may determine that the cell is a sleeping cell.

The test processes for other loopback test points are similar so long as changes are made to a test signal on each loopback test point adaptively.

Further, according to another embodiment of the present invention, to determine a fault location of a base station, tests may be performed for multiple loopback test points of the base station 340b, and the fault location of the base station is determined according to test results of the multiple loopback test points.

In this case, after determining, according to the KPI, that a failure may occur in the cell, the control module 320b sends, to the execution module 330b, test commands for some or all loopback test points of the loopback test points 1 to 7, to perform a loopback test for each loopback test point. It should be noted that loopback tests for the loopback test points may be performed in a predetermined sequence or concurrently, which is not specifically limited in the embodiment of the present invention.

The execution module 330b performs a loopback test according to the test command of the control module 320b. Functions of the execution module 330b for performing a loopback test are similar to the functions of the execution module 330a in FIG. 3a, and are not further described herein.

The execution module 330b determines whether a loopback test for each loopback test point n (n=1, 2, 3, . . . , 7) is successful, and feeds back a result of the loopback test to the control module 320b.

The control module 320b determines a fault location according to a result of the loopback test of each loopback test point. For example, when the test for the loopback test point 3 fails but the test for the loopback test point 4 is successful, the control module 320b may determine that a fault is located between the loopback test point 3 and the loopback test point 4, that is, the fault is on the L1 module.

It should be noted that the control module 320b may be located in an access network (for example, a base station or a base station controller) or may in a management network (for example, a network management system). The execution module 330b may be located in the access network. The modules may be separate modules located in the same or different physical entities or be implemented by using one physical entity or logical entity.

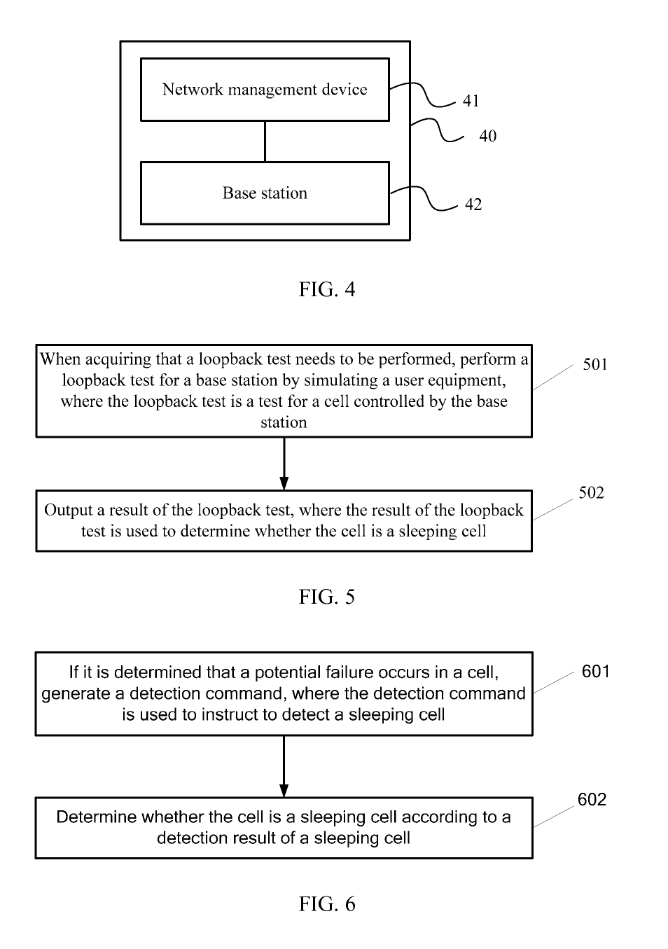

FIG. 4 is a block diagram of a system for detecting a sleeping cell according to another embodiment of the present invention. A system 40 in FIG. 4 includes a network management device 41 and a base station 42.

The network management device 41 is configured to generate a detection command, where the detection command is used to instruct the base station 42 to perform a loopback test for a cell controlled by the base station 42. The base station 42 is configured to receive a detection command from the network management device 41, perform a loopback test for the cell by simulating a user equipment, generate a detection result of a sleeping cell for the network management device 41 according to a result of the loopback test, and send the detection result of the sleeping cell to the network management device 41. The network management device 41 is further configured to determine, according to the detection result of the sleeping cell, whether the cell is a sleeping cell. Optionally, the base station 42 determines a loopback test object according to the detection command.

In the embodiment of the present invention, a loopback test is performed for the base station by simulating a user equipment, so that information needed to determine a sleeping cell can be obtained timely and a detection result of a sleeping cell can be determined. In this way, a sleeping cell can be discovered timely without assistance of the user equipment in a cell.

Optionally, as an embodiment, the network management device 41 can generate a detection command when determining that a potential failure occurs in a cell.

Optionally, as another embodiment, when the detection result of the sleeping cell indicates that detection is successful, the network management device 41 determines that the cell is not a sleeping cell; when the detection result of the sleeping cell indicates that the detection fails, the network management device 41 determines that the cell is a sleeping cell.

Optionally, as another embodiment, the base station 42 may perform a loopback test for each loopback test point of at least one loopback test point, where the at least one loopback test point is an antenna port of the base station 42 or distributed between the antenna port of the base station 42 and a core network, for example, as shown in FIG. 3a to FIG. 3b.

Optionally, as another embodiment, the base station 42 may further determine a fault location according to loopback test results of two loopback test points of the at least one loopback test point. In this way, the accuracy of locating a fault can be increased.

Optionally, as another embodiment, the base station 42 can call a cell controlled by the base station by simulating the user equipment, and determine a result of the loopback test according to whether the call is successful.

Optionally, as another example, the base station 42 can send a test signal to a loopback test point, where the test signal is used to initiate a call to a cell controlled by the base station. A feedback signal in response to the test signal is received at the loopback test point; if the feedback signal indicates that the call is successful, an output result of the loopback test is that the loopback test is successful; if the feedback signal indicates that the call fails, an output result of the loopback test is that the loopback test fails.

Or, according to another embodiment, the base station 42 sends a test signal to a loopback test point, where the test signal is used to initiate a call to a cell controlled by the base station. If a feedback signal in response to the test signal is received at the loopback test point, an output result of the loopback test is that the loopback test is successful; if no feedback signal in response to the test signal is received at the loopback test point, an output result of the loopback test is that the loopback test fails.

Optionally, as another embodiment, when the result of the loopback test indicates that the loopback test is successful, the base station 42 may output a detection result of a sleeping cell indicating that the cell is not a sleeping cell; when the result of the loopback test indicates that the loopback test fails, the base station 42 outputs a detection result of a sleeping cell indicating that the cell is a sleeping cell.

The network management device 41 and the base station 42 may include modules shown in FIG. 1, FIG. 2 or FIG. 3a to FIG. 3b. For example, in an example, the network management device 41 may include the control module 101 in FIG. 1, and the base station 42 may include the execution module 102 in FIG. 1. In another example, the base station 42 may include the control module 101 and the execution module 102 in FIG. 1.

Or, in an example, the network management device 41 may include the monitoring module 203 and the control module 201 in FIG. 2, and the base station 42 may include the execution module 202 in FIG. 2. As another example, the network management device 41 may include the monitoring module 203 in FIG. 2, and the base station 42 may include the control module 201 and the execution module 202 in FIG. 2. Or, the base station 42 may include the monitoring module 203, the control module 201, and the execution module 202 in FIG. 2.

Therefore, for details about other functions and operations of the network management device 41 and the base station 42, reference may be made to the FIG. 1, FIG. 2, and FIG. 3a to FIG. 3b, and the details are not repeatedly described herein.

FIG. 5 is a schematic flowchart of a method for detecting a sleeping cell according to an embodiment of the present invention. The method illustrated in FIG. 5 may be performed by a base station.

501. When acquiring that a loopback test needs to be performed, perform a loopback test for a base station by simulating a user equipment, where the loopback test is a test for a cell controlled by the base station.

Optionally, as an embodiment, it can be acquired, according to a received test command, that a loopback test needs to be performed, where the test command is used to instruct to perform a loopback test. For example, the test command may be generated when it is determined that a potential failure occurs in the cell.

Optionally, as another embodiment, as described in embodiments illustrated in FIG. 3a to FIG. 3b, the test command in step 501 may be generated for at least one loopback test point of the base station, where the at least one loopback test point is an antenna port of the base station or distributed between the antenna port of the base station and a core network. In this case, in the embodiment of the present invention, a fault location of the base station can be determined according to loopback test results of two loopback test points of the at least one loopback test point.

Optionally, as another embodiment, a call may be initiated to a base station by simulating a user equipment, where the call is a call for a cell controlled by the base station, and a result indicating whether the call is successful is used as a result of the loopback test.

For example, a test signal can be sent to the base station, where the test signal is used to initiate a call to a cell controlled by the base station, and a feedback signal from the base station in response to the test signal is received. If the feedback signal indicates that the call is successful, an output result of the loopback test is that the loopback test is successful; if the feedback signal indicates that the call fails, an output result of the loopback test is that the loopback test fails.

Or, for example, a test signal can be sent to the base station, where the test signal is used to initiate a call to a cell controlled by the base station. If a feedback signal in response to the test signal is received from the base station, an output result of the loopback test is that the loopback test is successful; if no feedback signal in response to the test signal is received from the base station, an output result of the loopback test is that the loopback test fails.

502. Output a result of the loopback test, where the result of the loopback test is used to determine whether the cell is a sleeping cell.

Optionally, as an embodiment, when a result of the loopback test indicates that a loopback test is successful, it is determined that the cell is not a sleeping cell; when a result of the loopback test indicates that a loopback test fails, it is determined that the cell is a sleeping cell.

In the embodiment of the present invention, a loopback test is performed for a base station by simulating a user equipment, so that information needed to determine a sleeping cell can be obtained timely and a detection result of a sleeping cell can be determined. In this way, a sleeping cell can be discovered timely without the assistance of the user equipment in a cell.

For details about each step of the method illustrated in FIG. 5, reference may be made to operations or functions of the base station in the system 100, system 200, system 300a to system 300b or system 40, and the details are not further described to avoid repetitive description.

FIG. 6 is a flowchart of a method for detecting a sleeping cell according to another embodiment of the present invention. The method illustrated in FIG. 6 may be performed by a network management device.

601. If it is determined that a potential failure occurs in a cell, generate a detection command, where the detection command is used to instruct to detect a sleeping cell.

602. Determine, according to a detection result of a sleeping cell, whether the cell is a sleeping cell.

Optionally, as an embodiment, when the detection result of the sleeping cell indicates that the detection is successful, it is determined that the cell is not a sleeping cell; when the detection result of the sleeping cell indicates that the detection fails, it is determined that the cell is a sleeping cell.

Optionally, as another embodiment, before whether the cell is a sleeping cell is determined according to the detection result of the sleeping cell, a test command may also be generated according to the detection command for a sleeping cell, where the test command is used to instruct to perform a loopback test. A detection result of a sleeping cell may also be determined according to a result of the loopback test.

Optionally, as another embodiment, when the result of the loopback test indicates that the loopback test is successful, a detection result of a sleeping cell indicating that the cell is not a sleeping cell is output; when the result of the loopback test indicates that the loopback test fails, the a detection result of a sleeping cell indicating that the cell is a sleeping cell is output.

In the embodiment of the present invention, a loopback test is performed for a base station by simulating a user equipment, so that information needed to determine a sleeping cell can be obtained timely and a detection result of a sleeping cell can be determined. In this way, a sleeping cell can be discovered timely without assistance of the user equipment in a cell.

Optionally, as an embodiment, the test command generated in step 601 may be generated for at least one loopback test point of the base station, where the at least one loopback test point is an antenna port of the base station or distributed between the antenna port of the base station and a core network. In this case, a fault location of the base station can be determined according to loopback test results of two loopback test points of the at least one loopback test point. In this way, the accuracy of locating a fault can be increased.

For details about each step of the method illustrated in FIG. 6, reference may be made to operations or functions of the network management device in the system 100, system 200, system 300a to system 300b or system 40, and the details are not further described to avoid repetitive description.

In each embodiment of the present invention, a module (or a device) performs a loopback test for an object by simulating a user equipment, which may be understood as follows: when the module or the device performs a loopback test, a loopback test object is considered as that the module or device is simulating functions of the user equipment or that the module or device performs the role of the user equipment in process of the loopback test, where the loopback test object may be a base station or a cell controlled by the base station.

Persons of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit are implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The computer software product is stored in a storage medium and includes several instructions for instructing a computer device (which may be a personal computer, a server, or a network device) to perform all or a part of steps of the methods described in the embodiments of the present invention. The storage medium includes: any medium that can store program codes, such as a USB flash disk, a removable hard disk, a ROM (Read-Only Memory), a RAM (Random Access Memory), a magnetic disk, or an optical disk.

The foregoing description is merely about specific embodiments of the present invention, but is not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the appended claims.

What is claimed is:

1. A system for detecting a sleeping cell, comprising a network management device and a base station, wherein:
the network management device is configured to send a detection command, wherein the detection command is used to indicate performing a loopback test for the base station, wherein the loopback test is a test for a cell controlled by the base station;
the base station is configured to receive the detection command from the network management device, perform the loopback test for the cell by simulating the user equipment, generate a detection result of a sleeping cell according to a result of the loopback test, and send the detection result of the sleeping cell to the network management device; and
the network management device is further configured to determine whether the cell is a sleeping cell according to the detection result of the sleeping cell.

2. The system according to claim 1, wherein the network management device is specifically configured to generate the detection command when it is determined that a potential failure occurs in the cell.

3. The system according to claim 1, wherein the network management device is specifically configured to determine that the cell is not a sleeping cell when the detection result of the sleeping cell indicates that detection is successful and determine that the cell is a sleeping cell when the detection result of the sleeping cell indicates that the detection fails.

4. The system according to claim 1, wherein the base station is specifically configured to perform the loopback test for each loopback test point of at least one loopback test point, wherein the at least one loopback test point is an antenna port of the base station or is distributed between an antenna port of the base station and a core network.

5. The system according to claim 4, wherein the base station is further configured to determine a fault location according to loopback test results of two loopback test points of the at least one loopback test point.

6. The system according to claim 4, wherein the base station is specifically configured to initiate a call by simulating a user equipment to the cell controlled by the base station, and determine a result of the loopback test according to whether the call is successful.

7. The system according to claim 6, wherein the base station is specifically configured to send a test signal to the loopback test point, wherein the test signal is used to initiate the call to the cell controlled by the base station, and receive a feedback signal in response to the test signal at the loopback test point; if the feedback signal indicates that the call is successful, an output result of the loopback test is that the loopback test is successful; if the feedback signal indicates that the call fails, an output result of the loopback test is that the loopback test fails; or,
the base station is specifically configured to: send a test signal to a loopback test point, wherein the test signal is configured to initiate a call to the cell controlled by the base station; if a feedback signal in response to the test signal is received at the loopback test point, an output result of the loopback test is that the loopback test is successful; if no feedback signal in response to the test signal is received at the loopback test point, an output loopback test result is that the loopback test fails.

8. A method for detecting a sleeping cell, comprising:
when acquiring that a loopback test needs to be performed, performing a loopback test for a base station by simulating a user equipment, wherein the loopback test is a test for a cell controlled by the base station; and
outputting a result of the loopback test, wherein the result of the loopback test is used to determine whether the cell is a sleeping cell.

9. The method according to claim 8, wherein that a loopback test needs to be performed is acquired according to a received test command, wherein the test command is used to instruct to perform a loopback test.

10. The method according to claim 8, further comprising:
generating the test command when it is determined that a potential failure occurs in the cell.

11. The method according to claim 8, further comprising:
when the result of the loopback test indicates that the loopback test is successful, determining that the cell is not a sleeping cell; and
when the result of the loopback test indicates that the loopback test fails, determining that the cell is a sleeping cell.

12. The method according to claim 9, wherein the test command is generated for at least one loopback test point of the base station, wherein the at least one loopback test point is an antenna port of the base station or is distributed between an antenna port of the base station and a core network.

13. The method according to claim 12, further comprising:
determining a fault location of the base station according to loopback test results of two loopback test points of the at least one loopback test point.

14. The method according to claim 8, wherein the performing a loopback test for a base station by simulating a user equipment, wherein the loopback test is a test for a cell controlled by the base station comprises:
initiating a call to the base station by simulating the user equipment, wherein the call is a call to the cell controlled by the base station, and using a result indicating whether the call is successful as a result of the loopback test.

15. The method according to claim 14, wherein the initiating a call to the base station by simulating the user equipment, wherein the call is a call to the cell controlled by the base station, and using a result indicating whether the call is successful as a result of the loopback test, comprise:
sending a test signal to the base station, wherein the test signal is used to initiate the call to the cell controlled by the base station, and receiving a feedback signal from the base station in response to the test signal; if the feedback signal indicates that the call is successful, an output result of the loopback test being that the loopback test is successful; if the feedback signal indicates that the call fails, an output result of the loopback test being that the loopback test fails; or,
sending a test signal to the base station, wherein the test signal is used to initiate the call to the cell controlled by the base station, and if a feedback signal in response to the test signal is received from the base station, an output result of the loopback test being that the loopback test is successful; if no feedback signal in response to the test signal is received from the base station, an output result of the loopback test being that the loopback test fails.

16. A method for detecting a sleeping cell, comprising:
if it is determined that a potential failure occurs in a cell, generating a detection command, wherein the detection command is used to instruct to detect a sleeping cell; and
determining whether the cell is a sleeping cell according to a detection result of a sleeping cell.

17. The method according to claim 16, wherein the determining whether the cell is a sleeping cell according to a detection result of a sleeping cell, comprises:
when the detection result of the sleeping cell indicates that detection is successful, determining that the cell is not a sleeping cell; when the detection result of the sleeping cell indicates that detection fails, determining that the cell is a sleeping cell.

18. The method according to claim 16, wherein before the determining whether the cell is a sleeping cell according to a detection result of a sleeping cell, the method further comprises:
generating a test command according to the detection command for a sleeping cell, wherein the test command is used to instruct to perform a loopback test; and
determining the detection result of the sleeping cell according to a result of the loopback test.

19. The method according to claim 18, wherein the determining the detection result of the sleeping cell according to a result of the loopback test, comprises:
when the result of the loopback test indicates that the loopback test is successful, outputting a detection result of a sleeping cell indicating that the cell is not a sleeping cell; when the result of the loopback test indicates that the loopback test fails, outputting a detection result of a sleeping cell indicating that the cell is a sleeping cell.

20. The method according to claim 18, wherein the test command is generated for at least one loopback test point of a base station, wherein the at least one loopback test point is an antenna port of the base station or is distributed between an antenna port of the base station and a core network.
